(19) United States
(12) Patent Application Publication
(10) Pub. No.: US 2016/0331628 A1
(43) Pub. Date: Nov. 17, 2016

(54) Massage roller

(71) Applicant: Jen-Tsu Kuo, Changhua (TW)

(72) Inventor: Jen-Tsu Kuo, Changhua (TW)

(21) Appl. No.: 15/222,973

(22) Filed: Jul. 29, 2016

(51) Int. Cl. A61H 15/00; A61H 7/00

(52) U.S. Cl. CPC A61H 15/00; A61H 7/007; A61H 2015/0014

(57) ABSTRACT

A massage roller is provided with an elongated, hollow, cylindrical roller core including a first end member and a second end member; and a cylindrical roller body disposed on the roller core and including a plurality of projections formed on an outer surface, and a plurality of grooves formed on the outer surface between the projections.

### BACKGROUND OF THE INVENTION

1. Field of the Invention

The invention relates to massage devices and more particularly to a massage roller having improved characteristics.

2. Description of Related Art

Massage has long been used to relieve various muscle and tendon ailments. Accordingly, there are a wide variety of massage devices known in the art for massaging muscles.

While some massage devices enjoy their success in the market, continuing improvements in the exploitation of massage device are constantly being sought.

### SUMMARY OF THE INVENTION

It is therefore one object of the invention to provide a massage roller comprising an elongated, hollow, cylindrical roller core including a first end member and a second end member; and a cylindrical roller body disposed on the roller core and including a plurality of projections formed on an outer surface, and a plurality of grooves formed on the outer surface between the projections.

The above and other objects, features and advantages of the invention will become apparent from the following detailed description taken with the accompanying drawings.

### BRIEF DESCRIPTION OF THE DRAWINGS

FIG. 1 is an exploded view of a massage roller according to a first preferred embodiment of the invention;

FIG. 2 is an exploded, perspective view of the partially assembled massage roller;

FIG. 3 a perspective view of the assembled massage roller;

FIG. 3A is a side view of the massage roller of FIG. 3;

FIG. 4 schematically depicts the massage roller being used to massage the lumbar of a user;

FIG. 5 schematically depicts the massage roller being used to massage the lower leg of the user;

FIG. 6 schematically depicts the massage roller being used to massage the thoracic part of the user;

FIG. 7 schematically depicts the massage roller being used to massage the thigh of the user;

FIG. 8 is a side view showing the part of the body of the user being rubbed by the projections of the massage roller;

FIG. 9 is a sectional view of a massage roller according to a second preferred embodiment of the invention;

FIG. 10 is a sectional view of a massage roller according to a third preferred embodiment of the invention;

FIG. 11 is a perspective view of a massage roller according to a fourth preferred embodiment of the invention;

FIG. 11A is a side view of the massage roller of FIG. 11;

FIG. 12 is a perspective view of a massage roller according to a fifth preferred embodiment of the invention;

FIG. 12A is a side view of the massage roller of FIG. 12;

FIG. 13 is a perspective view of a massage roller according to a sixth preferred embodiment of the invention; and

FIG. 13A is a side view of the massage roller of FIG. 13.

### DETAILED DESCRIPTION OF THE INVENTION

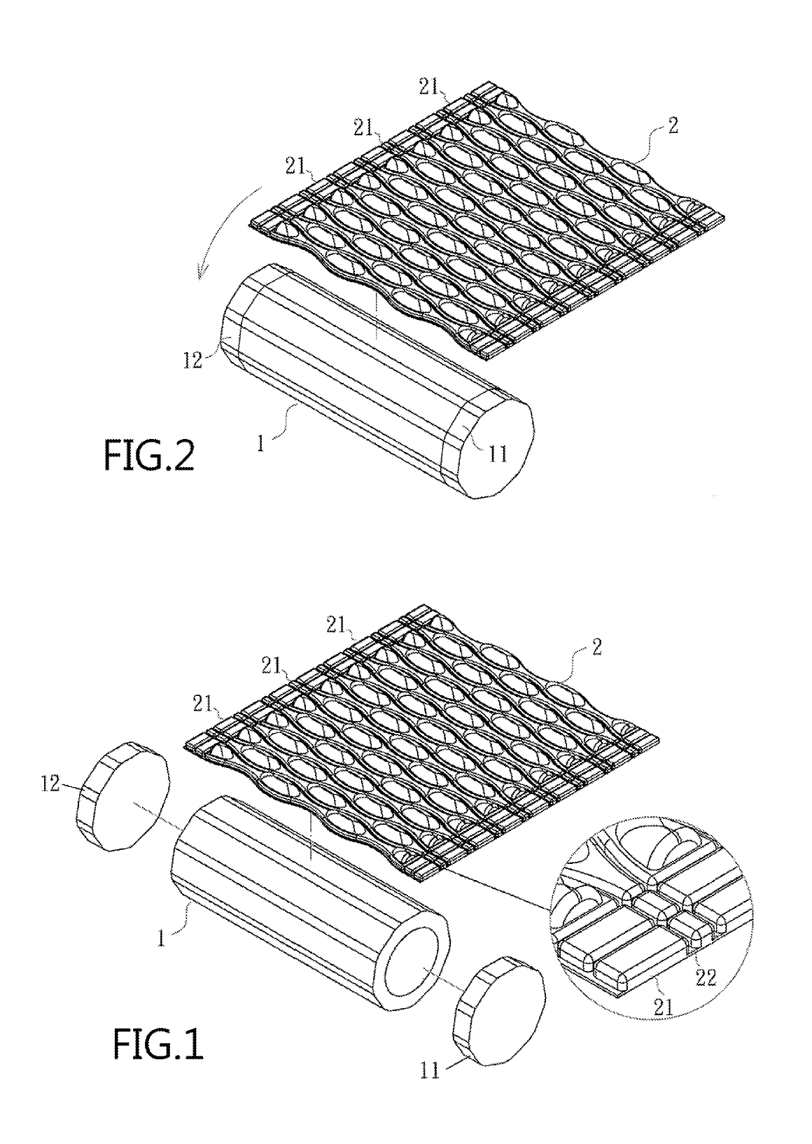

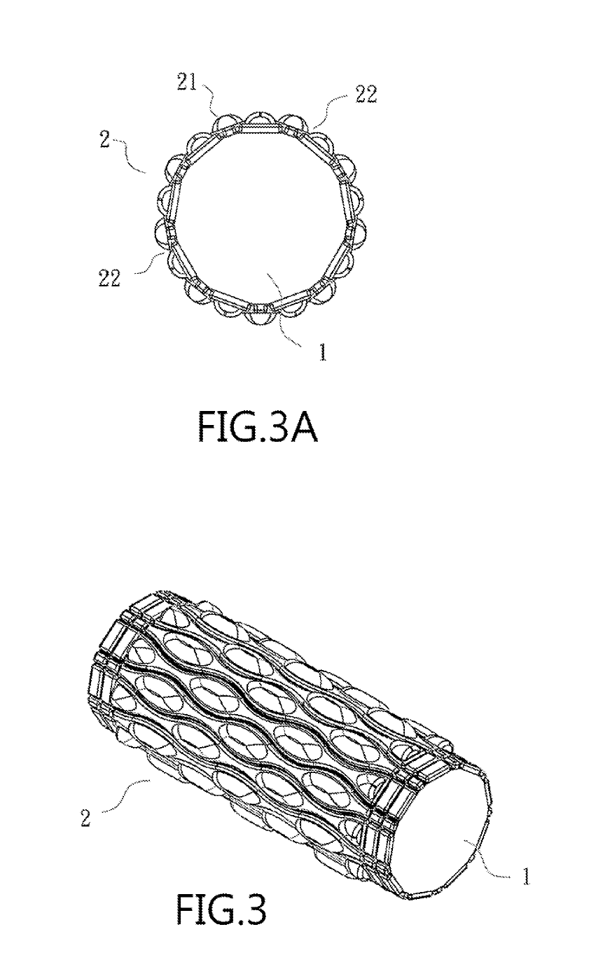

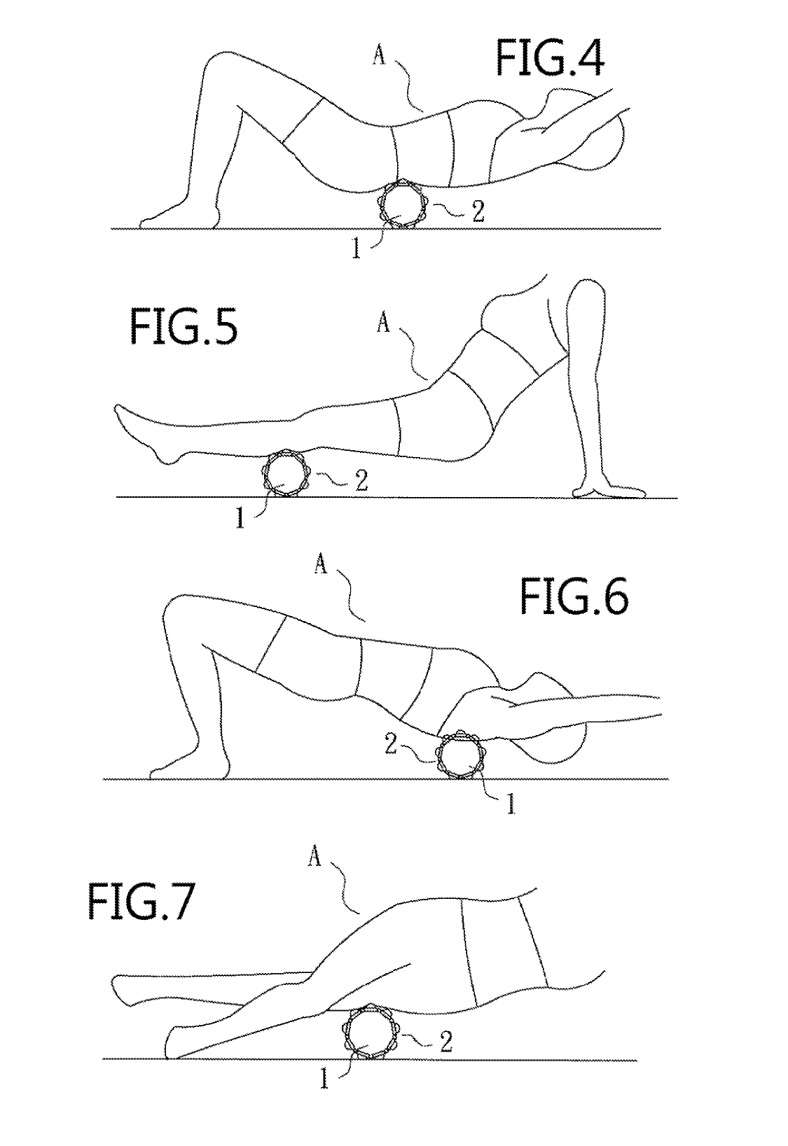

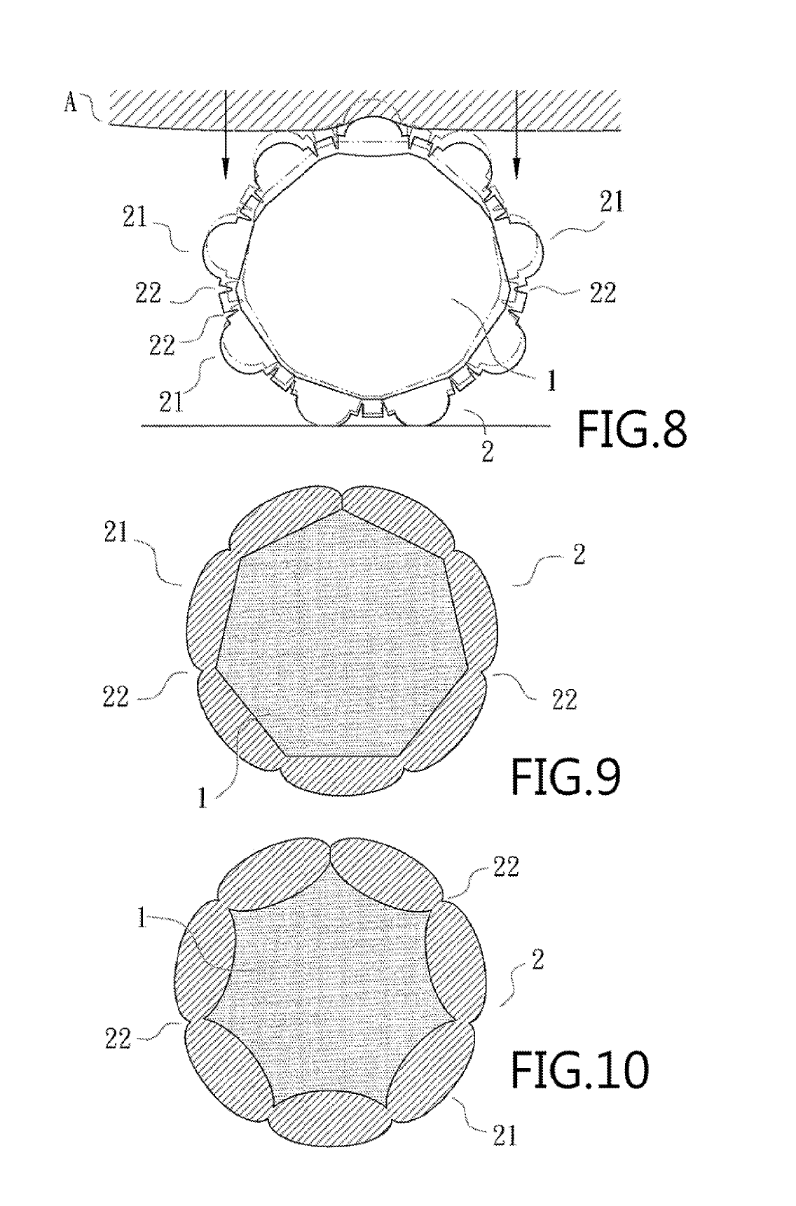

Referring to FIGS. 1 to 8, a massage roller in accordance with a first preferred embodiment of the invention comprises the following components as discussed in detail below.

An elongated, hollow, cylindrical roller core 1 includes a first end member 11 and a second end member 12. A cylindrical roller body 2 is provided on the roller core 1 and includes a plurality of projections 21 formed on an outer surface, and a plurality of grooves 22 formed on the outer surface between the projections 21.

A user A may use the massage roller to rub or knead the parts of the body (see FIGS. 4 to 8).

Referring to FIG. 9, a massage roller in accordance with a second preferred embodiment of the invention is shown. The characteristics of the second preferred embodiment are substantially the same as that of the first preferred embodiment except the following: The roller core 1 has a hexagonal cross-section and the projection 21 is formed on each of the six surfaces.

Referring to FIG. 10, a massage roller in accordance with a third preferred embodiment of the invention is shown. The characteristics of the third preferred embodiment are substantially the same as that of the first preferred embodiment except the following: The roller core 1 has six parallel recesses on its surface and the projection 21 is formed on each recess in a complementary fashion.

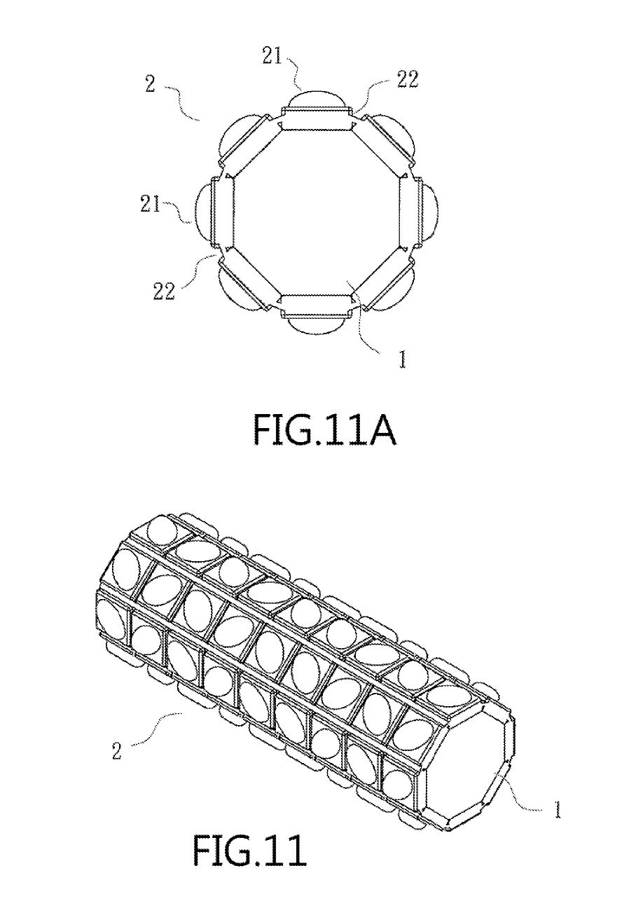

Referring to FIGS. 11 and 11A, a massage roller in accordance with a fourth preferred embodiment of the invention is shown. The characteristics of the fourth preferred embodiment are substantially the same as that of the first preferred embodiment except the following: the roller core 1 has an eight-sided cross-section and the projection 21 is formed on each of the eight surfaces.

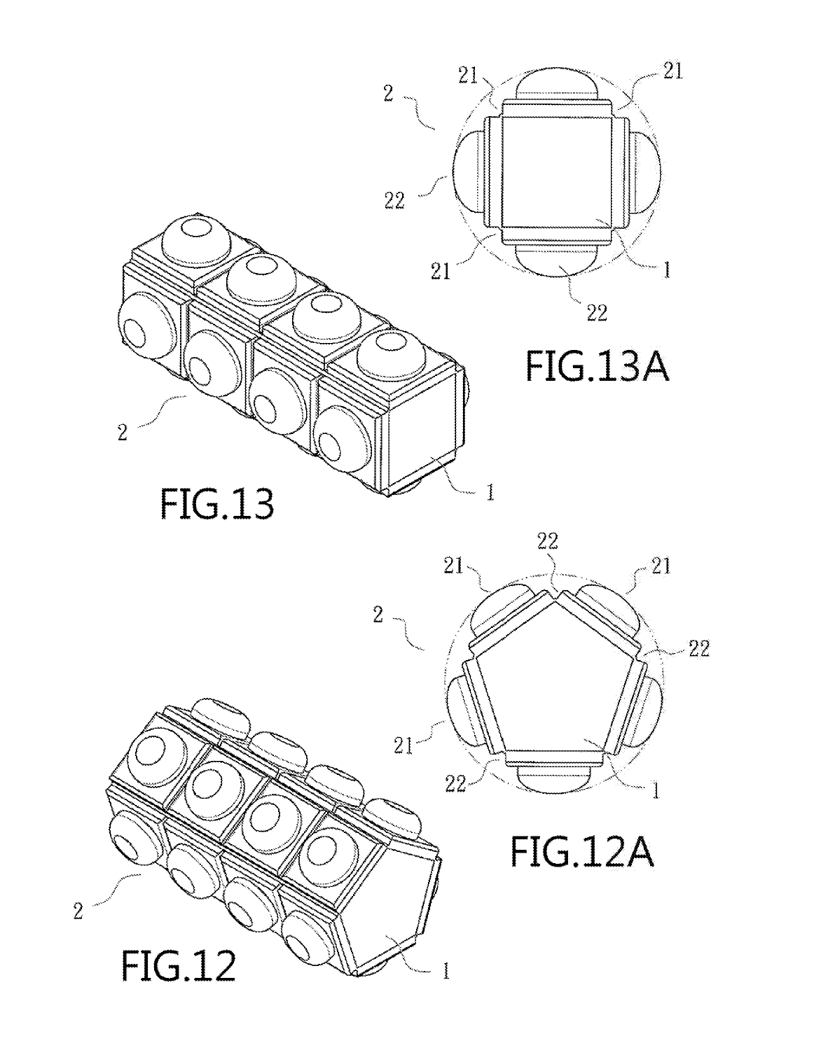

Referring to FIGS. 12 and 12A, a massage roller in accordance with a fifth preferred embodiment of the invention is shown. The characteristics of the fifth preferred embodiment are substantially the same as that of the first preferred embodiment except the following: The roller core 1 has a pentagonal cross-section and the projection 21 is formed on each of the five surfaces.

Referring to FIGS. 13 and 13A, a massage roller in accordance with a sixth preferred embodiment of the invention is shown. The characteristics of the sixth preferred embodiment are substantially the same as that of the first preferred embodiment except the following: The roller core 1 has a square cross-section and the projection 21 is formed on each of the four surfaces.

While the invention has been described in terms of preferred embodiments, those skilled in the art will recognize that the invention can be practiced with modifications within the spirit and scope of the appended claims.

What is claimed is:

1. A massage roller comprising:
an elongated, hollow, cylindrical roller core including a first end member and a second end member; and
a cylindrical roller body disposed on the roller core and including a plurality of projections formed on an outer surface, and a plurality of grooves formed on the outer surface between the projections.
